(19) United States
(12) Patent Application Publication
(10) Pub. No.: US 2006/0110707 A1
(43) Pub. Date: May 25, 2006

(54) Dental implant

(76) Inventors: Michael Perez Davidi, Savion (IL); Haim Levy, Hod Hasharon (IL)

Correspondence Address: DANIEL J SWIRSKY, 55 REUVEN ST., BEIT SHEMESH, 99544, IL

(21) Appl. No.: 10/992,702

(22) Filed: Nov. 22, 2004

(51) Int. Cl. A61C 8/00

(52) U.S. Cl. 433/173; 433/174

(57) ABSTRACT

The present invention discloses a novel dental implant anchored to the jawbone by at least two immobilizing means in the jawbone's intrabony portions comprising the proximal crest, medulla and distal crest; suprabony portions or any combination thereof such that the implant is rendered durable to withstand both lateral and perpendicular forces. The present invention also presents kits of multi-anchored dental implants and new methods of implanting the same.

### FIELD OF THE INVENTION

The present invention generally relates to dental reconstruction. More specifically, the present invention relates to a trans-endodontal implant, a dental implant combining self-drilling and self-milling means and a method of implanting the same.

### BACKGROUND OF THE INVENTION

Dental implants are widely known and used in the art of dental reconstruction. Dental implant are typically a bolt-like element, made of titanium or stainless steel, being screwed to the jawbone, for replacing a root portion of a missing tooth, or generally serving as anchoring means for a dental prosthesis or constructions of multi-teeth systems; an artificial tooth, crown or bridge structure are placed thereon, to resemble natural teeth.

A main concern in dental implants design and implanting procedures is fixating the implant into the implanting site and securing it well-fastened to the jawbone, such that it can withstand strong forces applied to the teeth by mastication; the slightest mobility of the implant inside the bone may lead to inflammations and lesions and eventually to implant rejection.

Bone tissue is functionally divided into a cortical bone region (or “crest”) with an elastic modulus of between 1000 and 1200 dN/mm and a spongy region of trabecular bone tissue containing medulla or fat, with an elastic modulus of roughly between 20 and 400 dN/mm.

Reference is thus made now to FIG. 1A, presenting a schematic and generalized cross-section lateral view of the jawbone, typically revealing a U-like shape crest (1) circumferential to the medullar region (2). FIG. 1B presents yet a second cross-section at a perpendicular plane to the one shown in FIG. 1A, further revealing a triple-tiered bone tissue histology, wherein the two extreme layers, i.e. the first bone layer (1a), and the second bone layer (1b), are crest or cortical bone layers, and the intermediate layer (2) is a medullar bone layer.

A commercially available implant as depicted in FIG. 2A is penetrating the bone crest (1) in known procedures wherein its proximal portion (e.g., abutment member, 3) is facing the oral cavity, and the screw-like distal portion (5) is anchored in the medullar portion (2) of the bone. Most of the anchoring strength of said implant is provided in a respectively narrow portion (4) entrapped strongly into the crest (1) at an anchoring plane (6). Being immobilized into the jawbone mostly by aforesaid hinge-like anchoring-plane (6), the longitudinal portion of the implant is having multiple degrees of freedom for movement inside said bone, as illustrated in FIG. 2B, namely vertical movement along the longitudinal axis (arrow 7A), two-dimensional planar movement, such as along arrows (7B, 7C); or any combination thereof. This hinge-like movement of implants in and around anchoring plane (6) continuously deteriorates bone condition as defined above.

Dental implants having a single anchoring-plane are hence known in the art, and widely fail to prevent both lateral and vertical implant movement inside the bone induced by the powerful forces applied to the teeth upon chewing and biting. A secure immobilization of the implant as in at least one additional anchoring plane, provided with no implant movement thus meets a long felt need.

Replacement or artificial teeth have become available as an answer to the loss of original teeth. Natural or original teeth are secured in place by roots, which cooperate with the body tissue. When a natural or original tooth is lost, the root is usually also lost. Secure attachment for the new tooth must be provided which will hold and support the tooth securely enough to resist forces generated in biting and chewing.

One class of replacements uses dental implants as tooth root replacements in the jawbone, with crowns, or other similar structures, which resemble teeth and gums, attached to the implants.

As already mentioned above, the implant's strength and endurance in the strong forces applied by mastication to the teeth ranging from 200N up to 500N is one major consideration in dental reconstruction; Other considerations involved in the designing of a dental implant are the manner of insertion of the implant into the jawbone and the procedure or procedures involved thereof; the longevity of each of such procedures; the total number of treatments necessary; the duration of the healing process; and, diminishing the risks of inflammations, infections or even rejection.

Vertically penetrating, intrabony positioned dental implants are widely known and used, a portion thereof are even self-drilling or self-tapping by means of a helical threaded or screw-like body adapted to be anchored in a jawbone, such as the self-drilling implant disclosed in US Patent Application 2003/0165796 to Carmichael et al. Dental implants of this sort or the like are effective in anchoring the tooth and securing it in place against lateral forces, i.e. forces in directions substantially orthogonal to the implant's longitudinal (vertical) axis; however, they are usually low-resistant against perpendicular forces, i.e. forces in directions substantially collinear with said longitudinal axis.

Against such perpendicular forces, there exist procedures and implants for horizontal penetration or insertion in an intrabony configuration; an example for such an implant and method is presented in U.S. Pat. No. 4,722,687 to Scortecci, disclosing a self-boring tool implant for forming a (reversed/upside-down) T-shaped slot in a jawbone, comprising a flat circular indented wheel having cutting teeth on its periphery, and an elongated shaft or rod secured coaxially to the wheel and having milling surfaces thereon. When placing the tool-implant laterally against the bony wall, the practitioner, in a straight-line translation movement, allows the intra and trans-osseous penetration in a plane parallel to that of the indented wheel, for the base or wheel (horizontal drilling). At the same time, a simultaneous penetration of the rod in a plane perpendicular to the base or wheel is achieved (vertical drilling). A drawback of this method is the requirement to perform a lateral cross-section incision in the jawbone area in order to lodge the implant into the implanting site, resulting in a multi-stage operation, implicating higher risks of infections and a longer healing process.

A similar yet not identical T-shaped anchor configuration is also illustrated in French Patent No. 2645011 to Serban, describing an implant provided in its lower part with two cylindrical pins for locking the implant to the bone. Prior to the positioning of the implant a corresponding T-shaped bore-hole is drilled in the bone, using a different tool. Several drawbacks of drilling with a different tool than the implant itself are already discussed in the background of Scortecci, such as bimetallism due to the different materials which the implant and the drilling tool are made of, the difficulty in matching the drill-bore to the size and shape of the implant, the prolongation of treatment by additional steps etc.

In parallel, there exist also horizontal suprabony constructions, essentially multi-teeth systems, bridges, dentures or the like, which are fastened to the jawbone by means of screws; often these constructions cause chronic inflammations, due to significant spacing or gaps formed between it and the bone and thus allowing for bacterial activity, eventually bringing to bone retraction and consequently to the weakening and/or loosening of the implant along time.

A cost-effective, simple, efficient, self-assembled implant having therein self-drilling and self-milling means, adapted for insertion in a single-step procedure, reducing number of treatments and treatment's duration, not involving a second incision or more in the bone, and provides with an appropriate response to the said perpendicular forces, as well as the protection of said lateral forces, securing the implant in place and further preventing counter-rotation thereof, thus meets a long felt need.

### SUMMARY OF THE INVENTION

It is thus an objective of the present invention to provide a dental implant anchored to the jawbone by at least two immobilizing means in the jawbone's intrabony portions comprising the proximal crest, medulla and distal crest; suprabony portions or any combination thereof such that the implant is rendered durable to withstand both lateral and perpendicular forces. A dental implant is hereto presented, adapted to be anchored to the jawbone by at least two immobilizing means in the jawbone's, characterized by a multi-screw shape adapted for be entrapped in jawbone's proximal crest, medulla and distal crest.

It is in the scope of the present invention to provide an efficient dental implant, kit and a method for implanting thereof, wherein said implant is having anchoring means exploiting the relatively higher elastic modulus of the cortical bone region and fixating the medullar penetrating portion of the implant to prevent movement thereof within the medulla, namely, an implant that in addition to penetrating the first cortex layer and the medulla is further having penetration and anchoring means to the second, opposite cortex layer, i.e. “crest-to-crest” penetrating implant, thereby achieving better strength and endurance thereof against movement and lateral grinding induced forces.

In the scope of the present invention is a multi-screw, trans-endodontal implant, characterized by a distal portion penetrating the jawbone, and a proximal portion facing the oral cavity, comprising a head member located at said proximal portion, having a central bore therein for receiving a dental prosthesis; at least one elongated screw-like envelope member, comprising an external sheath having an outer threaded surface and an internal cylindrical shaft extending from said head member to the distal end of said envelope member, said shaft is further adapted for accommodating therein an inner screw-like member; and, an inner screw-like member, having an elongated, threaded distal body portion, and a cylindrical proximal body portion having a circumferential O-ring disposed thereon, and a furrowed, hexagonal shaped cavity located at the proximal end thereof; wherein said envelope screw-like member is inserted into the jawbone, penetrating the proximal crest and medulla layers, the inner screw-like member is further exceeding perpendicularly from the distal end of the said envelope member and penetrating into the second crest layer.

In the scope of the present invention is also a method for implanting the said multi-screw, trans-endodontal implant, the method comprising: drilling into the jawbone at least one bore hole adapted for accommodating the said envelope member; screwing the said envelope member into said bore hole such that the external sheath thereof is penetrating perpendicularly the proximal crest and medulla layers; drilling into the jawbone a second bore hole within the first bore hole for accommodating the inner member; screwing said inner member into the second bore hole by means of fastening a bolting, optionally torque-transmitting tool having a hexagonal pillar shaped end in accordance with the said cavity at said inner member's proximal end; such that the inner member is further exceeding perpendicularly from the distal end of the said envelope member into the second crest layer.

In the scope of the present invention is also an efficient dental implant combining self-drilling and/or self-milling means. The self-drilling/milling implant is characterized by an elongated main (vertical) axis having a proximal portion facing the oral cavity, and a distal portion penetrating into the jawbone, comprising: an elongated, threaded surface body, root-replacement drill-like member located at said distal portion, having an external diameter d, a length l and a longitudinal axis coinciding with said implant's main axis; a rounded, mill-like member having an external diameter d1 centered in said implant's main axis and coaxial with a secondary (horizontal) axis located in a right angle with said implant's main axis, said mill-like member is characterized by a jagged milling surface in the distal end thereof facing the jawbone; an abutment located in the proximal end and exceeding from said mill-like member towards the oral cavity; wherein said drill-like member is adapted to penetrate perpendicularly to a depth of about l as to accommodate an intrabony portion of the jawbone, while the mill-like member is fixated in a diameter d1 to a suprabony portion of the jawbone.

Surprisingly, the dental implant according to the present invention is endowed with an improved durability to the forces generated during oral activity such as mastication or the like, and is resistant against perpendicular forces as well as lateral forces, yet the insertion thereof into a patient's jawbone is performed in a single-step operation, and does not require cutting a second incision or more in the patient's mouth, thus combining the advantages of vertical penetrating implants, i.e. short treatment and healing process and lesser risks of infection, with the strength and long-withstanding of laterally inserted implants, achieved due to the efficient fastening mechanism provided, securing in place the implant to the bone.

### BRIEF DESCRIPTION OF THE FIGURES

In order to understand the invention and to see how it may be implemented in practice, several embodiments will now be described, by way of non-limiting example only, with reference to the accompanying drawing, in which

FIG. 1A is a cross-section lateral view of the mandibular jawbone schematically and generally illustrated; FIG. 1B is yet a second cross-section at a perpendicular plane to the section plane shown in FIG. 1A;

FIG. 2A is illustrating a cross-section lateral view of the mandibular jawbone having an implant immobilized therein; FIG. 2B is schematically illustrating the same implant immobilized mainly by means of anchoring into plane 6.

FIG. 3 shows a lateral integral view of an assembled multi-screw trans-endodontal implant in accordance with one embodiment of the invention;

FIG. 4 is a cross-sectional lateral view of the multi-screw trans-endodontal implant of FIG. 3;

FIG. 5 presents an inferior view of the multi-screw trans-endodontal implant of FIG. 3;

FIG. 6 presents various exemplary shapes of the inner screw-like member's end tip schematically illustrated;

FIG. 7 depicts a schematic illustration of a multi-screw trans-endodontal implant comprising a plurality of cylindrical shaped envelope and inner members accommodated within one another;

FIG. 8 depicts a schematic illustration of a multi-screw trans-endodontal implant comprising a plurality of conic shaped envelope and inner members accommodated within one another;

FIG. 9 shows an integral, perspective view of the dental implant (100) combining self-drilling (101) and self-milling means (102) in accordance with one preferred embodiment of the present invention;

FIG. 10 shows an integral, perspective view of the dental implant (100) in accordance with yet another embodiment of the present invention, wherein said implant (100) is having a root replacement member with a smooth surface body (101), an abutment (103) and self-milling means (102);

FIG. 11 schematically illustrates a side view of various shapes of the self-milling means (2) of the dental implant (100) including: truncated cone (a), disc (b), and polygonal shape (c); and,

FIG. 12 schematically illustrates a side view of the dental implant in accordance with yet another embodiment of the invention, wherein the abutment (103) is exceeded in an angle theta (0) from the mill-like member (102) towards the oral cavity.

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a multi-screw trans-endodontal implant adapted for penetrating both cortical layers of the jawbone, a dental implant combining trans-endodontal implanting means, self-drilling and self-milling means or any combination thereof, kits and a method for implanting the same.

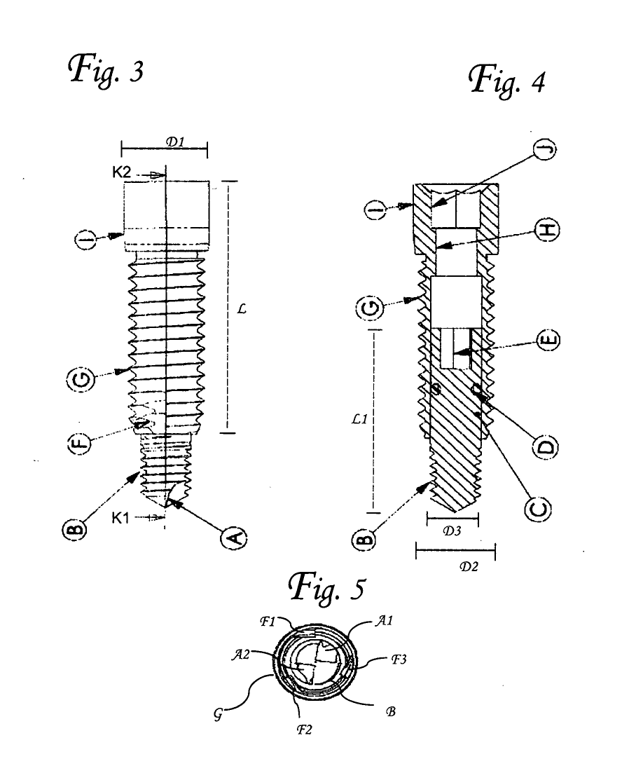

Reference is made now to FIG. 3, showing a lateral integral view of an assembled multi-screw trans-endodontal implant in accordance with one embodiment of the present invention. Said implant is characterized by a longitudinal axis having a distal portion (K1) penetrating the jawbone, and a proximal portion (K2) facing the oral cavity, and comprising a head member (I) located at said proximal portion; a envelope member (G), comprising an external elongated sheath of a screw-like, outer male threaded surface, adapted for accommodating the medullar region of the jawbone; and, an inner member (B), having an elongated, screw-like, male threaded distal body portion. The envelope member (G) may comprise at least one flute (F) located at the distal end thereof, to allow bone chips created during drilling to flow out from the implanting site. The inner member (B) may also comprise at least one flute (A), and may have additionally a tapered tip at the distal end thereof, in order to facilitate penetration into the second crest layer of the jawbone.

Reference is made now to FIG. 4, showing a cross-sectional lateral view of the multi-screw, trans-endodontal implant in accordance with the same embodiment. The implant comprising a central bore hole (J) within said head member (I) for receiving a dental prosthesis; an internal cylindrical shaft (H) extending from said head member (I) to the distal end of said envelope member (G). Said shaft is further adapted for accommodating therein the second screw-like member (B). The inner member (B) comprises a cylindrical proximal body portion (C) having a circumferential O-ring (D) disposed thereon, and a furrowed, hexagonal shaped cavity (E) located at the proximal end thereof. The O-ring seals and protects the internal portion of the implant from invasion of microorganisms and spreading from there up to other areas. The hexagonal shaped cavity (E) at the proximal portion of the inner member (B) provides means for gripping said inner member (B) by an appropriate torque-transmitting surgical tool having a hexagonal pillar shaped tip adapted for fastening into said cavity (E).

In accordance with one embodiment of the invention, the central bore hole (J) within said head member (I) is having a hexagonal shape.

In accordance with yet another embodiment of the invention, said central bore hole (J) within said head member (I) is having an internal threaded female groove for receiving a screw-like dental prosthesis structure.

In accordance with the embodiment described and illustrated in FIGS. 3 & 4, the diameter D1 of the head member (I) is ranging from 3.75 mm to 4.10 mm; The total length L of the head member (I) together with the envelope member (G) ranges from 6.0 mm to 16.0 mm; the length of the inner member (B) ranges from 4.0 mm to 30.0 mm; the diameter D2 of the envelope member (G) ranges from 1.50 mm to 3.10 mm, and the width of the side walls of the sheath thereof is approximately 0.3 mm; thus, the diameter D2 of the inner member ranges from about 1.44 mm to about 2.50 mm.

It is yet in the scope of the invention wherein, as shown in FIG. 4, the shaft may further comprise at least one proximal portion having a diameter smaller than the diameter of the inner member's cylindrical body portion accommodated at the shaft's distal portion, such that the surrounding sheath's side walls are thereby widened for improved strength and stability of the implant.

It is also in the scope of the invention wherein the said head member (I) further comprises means to accommodate an abutment cup, healing cup or splint, to be placed thereon after the implant is installed to allow proper osseointegration of the implant before attaching the dental prosthesis.

In accordance with another embodiment, the head member (I) may further include a joint, either stationary or mobile, as to enable adjustment of an abutment portion attached thereto at a desired angle.

Reference is made now to FIG. 5, presenting an inferior view of the implant in accordance with an embodiment of the invention, wherein the envelope member (G) is having three flutes (F1), (F2) & (F3), disposed at radial angle of about 120° against each other in the distal end thereof; and the inner member (B) is having two flutes (A1) & (A2) disposed in opposite directions at the distal end thereof.

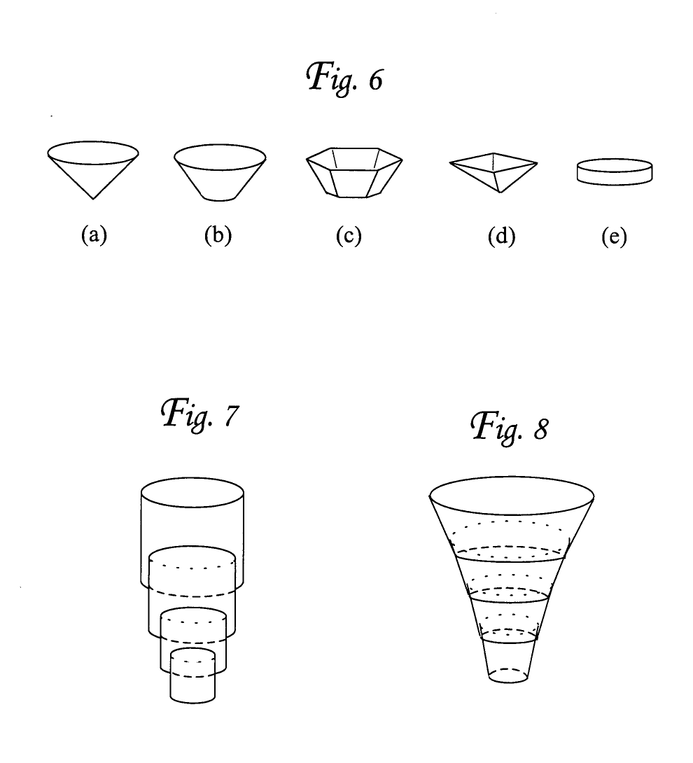

Reference is made now to FIG. 6, presenting yet various exemplary convex shapes for the inner member's tip schematically illustrated according to further embodiments, including: a tapered conic shape (a); a truncated conic shape (b); a polyhedron shape (c); a pyramid shape (d); a flat disc shape (e). Alternatively, said inner member tip may have a concave shape, or may additionally comprise bone glue or bone plaster for gluing it to the jawbone and/or gluing together bone parts that have been cut through during drilling.

In accordance with another embodiment of the present invention, the envelope member may further comprise at least one hole extending from one lateral end thereof to the opposite side, to allow bone tissue growth into the implant, thus providing further anchorage into the jawbone and enabling better osseointegration.

According to further embodiment, the implant may further comprise milling means at the proximal portion thereof, for milling the suprabony portion of the jawbone, thus fastening the implant further into the implanting site and providing support against perpendicular forces, in addition to protection of lateral forces.

It is yet in the scope of the present invention wherein the multi-screw implant comprises multiple envelope and/or inner screw-like members; reference is made now to FIG. 7, depicting a schematic illustration of such implant having a plurality of cylindrical shaped, serially or chain-connected envelope and inner members, exceeding outwardly from each other in a telescope-like segmentational manner.

The term ‘segmentational’ in the context of the present invention is referring to the edge line (contour) of the multi-screw implant contacting the bone tissue, wherein a plurality of cylindrical shaped and serially connected envelope/inner members are forming an echeloned-like surface.

In accordance with further embodiments, at least one of either the envelope or inner members may be in the shape of a truncated cone, as to facilitate homogenous growth of the bone around the implant and for avoidance of pocket formation, thus bringing to better osseointegration.

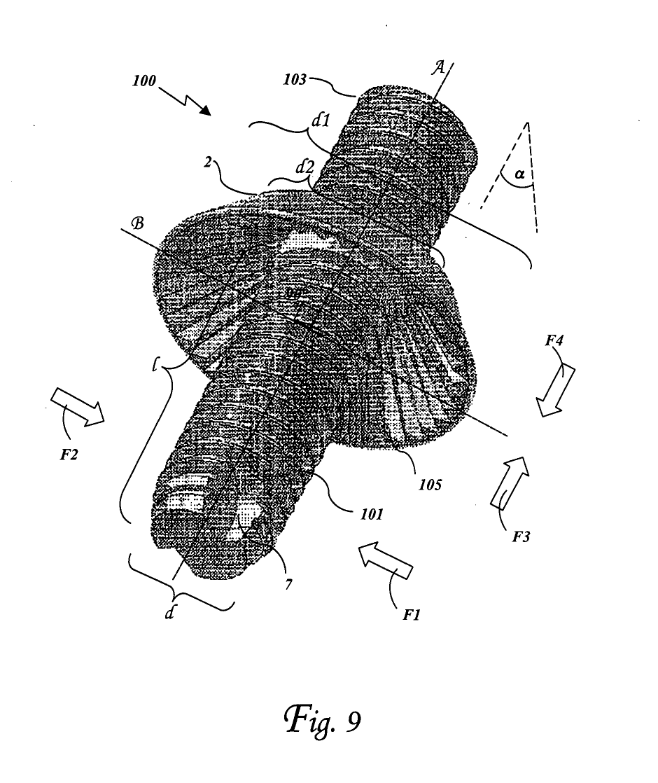

Reference is made now to FIG. 8, depicting a schematic illustration of a multi-screw trans-endodontal implant comprising a plurality of conic shaped, serially or chain-connected envelope and inner members, exceeding outwardly from each other in a telescope-like continuous manner.

It is acknowledged that the multi-screw implant according to the invention may also combine both conic and cylindrical shaped multiple envelope/inner members serially connected.

The implant in accordance with the invention is fabricated from materials selected in a non-limiting manner from the group consisting of titanium or titanium alloys, stainless steel, polymeric materials or compositions, composite materials, or any other suitable implant material which can withstand functional loads and support crowns, bridge segments, or the complete replacement of teeth with tooth forms/synthetic teeth/artificial teeth.

In accordance yet with a further embodiment of the present invention, an implant adapted for self-drilling is presented, eliminating the need to pre-drill a plurality of bore holes readily for screwing the implant into the jawbone; furthermore, both steps of drilling and screwing of the envelope and/or the inner member are thus performed simultaneously, thereby shortening the operation, reducing patient's inconvenience and infection risks.

It is yet in the scope of the present invention to provide with a useful method of implanting the aforementioned novel multi-screw, trans-endodontal implant according to the invention. The method is comprising inter alia the steps of drilling into the jawbone at least one bore hole adapted for accommodating therein the envelope member; screwing the envelope member into said bore hole such that the external sheath thereof is penetrating perpendicularly into the proximal crest and medulla layers; drilling into the jawbone a second bore hole within said first bore hole for accommodating therein the inner member; and, screwing the inner member into the second bore hole by means of fastening a torque-transmitting bolting tool having a hexagonal pillar shaped end in accordance with the said cavity located at said inner member's proximal end; such that the inner member is further exceeding perpendicularly from the distal end of the said envelope member into the second crest layer.

The present invention also relates a kit for a multi-screw, trans-endodontal implant, comprising an abutment module and a root replacement anchoring module. The abutment module comprises a head component, having therein a housing member for receiving a dental prosthesis structure. The anchoring module comprises a multi-screw system having at least one screw-like envelope component and at least one inner screw-like component. The envelope component comprises an outer portion and an inner portion; the outer portion comprises an elongated sheath having an external male threaded surface, and the inner portion comprises an internal cylindrical shaft extending throughout the longitudinal axis of said envelope component. The inner screw-like component comprises a screwing member, a sealing member, and a fastening member. The screwing member is having a male threaded surface adapted for accommodating the cortical region of the jawbone. The fastening member comprises a cylindrical body portion and a hexagonal shaped cavity located at the end thereof and facing outwardly of said inner component. The sealing member comprises a circumferential O-ring disposed on said cylindrical body of the fastening member.

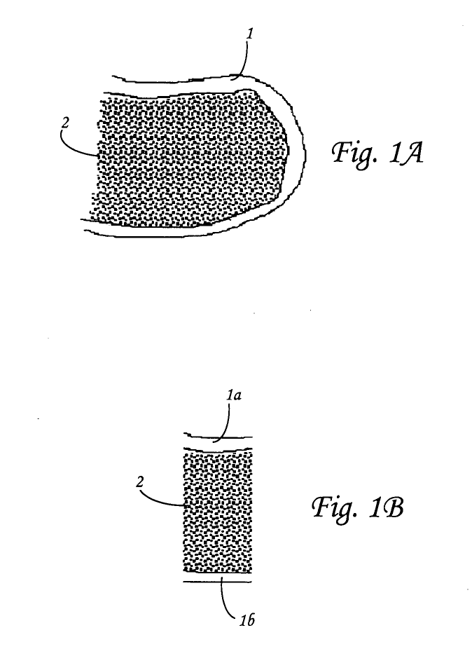

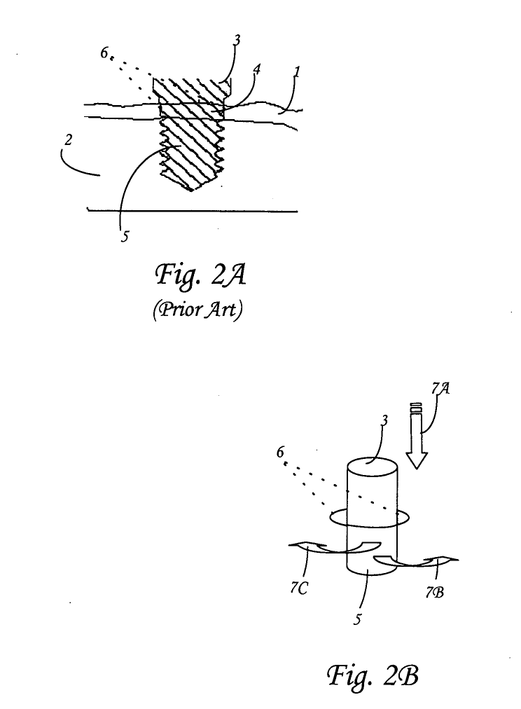

The present invention further relates to a method for treating humans such that a secure immobilization of the multi-screw, trans-endodontal dental implant as defined in any of the above is provided with no significant implant movement. More specifically, the present invention provides a novel method for avoiding the single hinge-like anchoring plane (See 6 in FIGS. 1A and 1B) in the manner of at least two anchoring planes substantially parallel yet spaced from one another. This method comprising inter alia the following steps: drilling into the jawbone at least one bore hole adapted for accommodating the said envelope member; screwing the said envelope member into said bore hole such that the external sheath thereof is penetrating perpendicularly the proximal crest and medulla layers such that a first anchoring plane is provided; drilling into the jawbone a second bore hole within the first bore hole for accommodating the inner member; and, screwing said inner member into the second bore hole by means of fastening a bolting tool having a hexagonal pillar shaped end in accordance with the cavity of said inner such that the distal crest is at least partially penetrated and a first anchoring plane is provided. This method is also provided useful wherein the implant is adapted for self-drilling and the steps of drilling and screwing the envelope and/or inner member are performed simultaneously.

It is to be appreciated that the envelope member is especially adapted to penetrate the proximal crest and has effective anchoring means to immobilize the implant in the medullar portion including substantially wide surface area in accordance with the crumbled texture of the medulla. The inner member is especially adapted to penetrate the distal crest and has substantially narrower diameter and surface area than of the envelope member, as to prevent neural injury, diminish the portion of bone material harvested during or prior to screwing said member into the bone, reduce heat level during drilling, and bringing to improved accuracy in performance.

Reference is thus made now to FIG. 9, showing an integral, perspective view of the dental implant (100) combining self-drilling (101) and self-milling means (102) in accordance with one embodiment of the present invention, said implant (100) is characterized by an elongated main (vertical) axis (A) having a proximal portion facing the oral cavity, and a distal portion penetrating into the jawbone. The dental implant (100) comprises an elongated, threaded surface body, root-replacement drill-like member (101) located at said distal portion, having an external diameter d, a length l and a longitudinal axis coinciding with said implant's main axis; adjacent to said drill-like member is a rounded, mill-like member (102) having an external diameter d1 centered in said implant's main axis (A) and coaxial with a secondary (horizontal) axis (B) located in a right angle with the main axis (A) of the implant (100), said mill-like member (102) is characterized by a jagged milling surface (105) in the distal end thereof facing the jawbone; located in the proximal end and exceeding from said mill-like member (102) towards the oral cavity is an abutment (3) for placing a dental prosthesis or structure thereon after the implant (100) is secured in place; wherein said drill-like member (101) is adapted to penetrate perpendicularly to a depth of about l as to accommodate an intrabony portion of the jawbone, while the mill-like member (102) is fixated in a diameter d1 to a suprabony portion of the jawbone, such that the implant (100) is rendered durable to withstand both lateral forces, as in the directions indicated by (F1) & (F2), and perpendicular forces, as in the directions indicated by (F3) & (F4).

In accordance with one embodiment, the drill-like member (101) is having at least one flute (107) in its distal end for allowing bone-chips created during cutting in the bone to flow in the proximal direction towards the oral cavity and out of the drilled bore-hole, thus facilitating both the drilling and drainage of bone litter.

The implant is inserted into the jawbone in a single-step procedure, by holding the implant with an appropriate surgical tool and applying rotational or torque movement thereto, such that the implant revolves around its main axis (A) so that the drill-like member penetrates an intrabony portion of the bone to a depth of about 1, and the mill-like member mills a suprabony portion of the bone of a diameter d1.

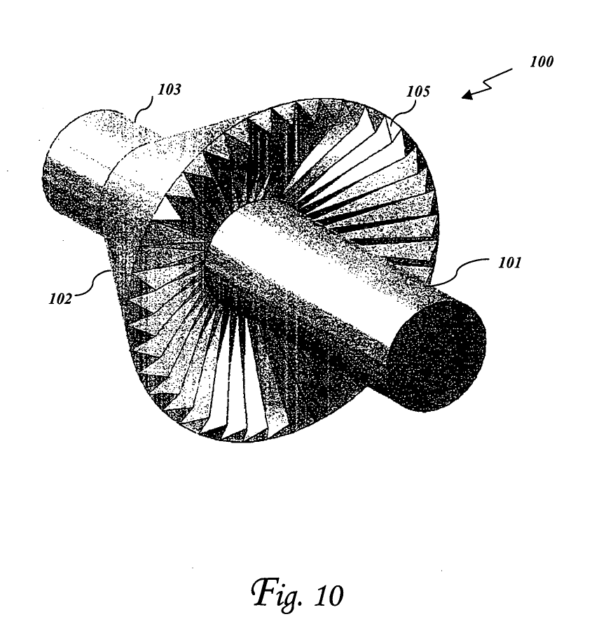

Reference is made now to FIG. 10, showing an integral, perspective view of the dental implant (100) in accordance with yet another embodiment of the present invention, wherein said implant (100) is having a smooth surface body (101) adapted for insertion into pre-drilled bore-hole, an abutment (103) and self-milling means (102). The abutment (103) can either have smooth or threaded surface body, in accordance with the structure used for the dental prosthesis.

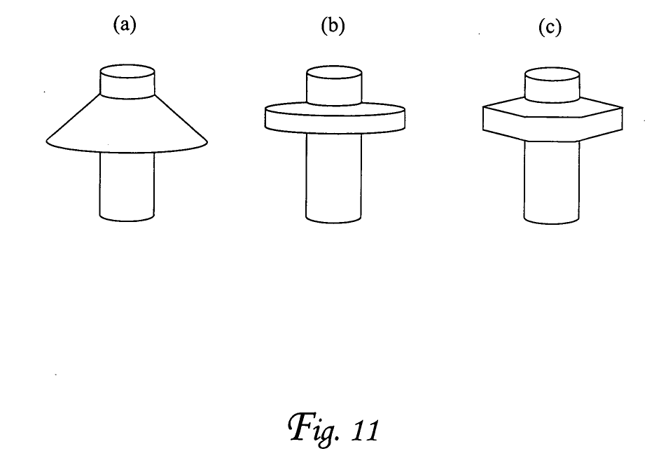

Reference is made now to FIG. 11, schematically illustrating in a non-limiting manner a side view of various shapes of the self-milling means (102) of the dental implant (100) including: truncated cone (a), disc (b), and polygonal shape (c). It is acknowledged that any other geometric shape is applicable, according to any functional or other considerations.

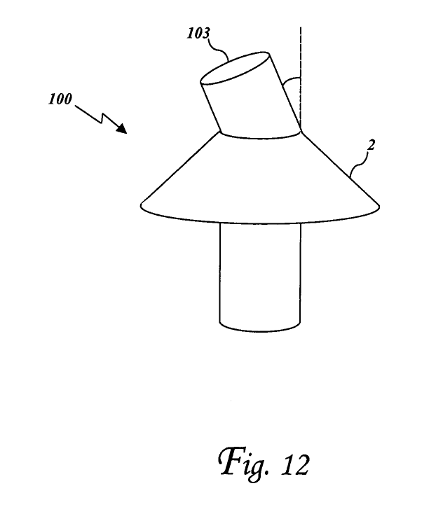

Reference is made now to FIG. 12, schematically illustrating a side view of the dental implant in accordance with yet another embodiment of the invention, wherein the abutment (3) is exceeded in an angle theta (0) from the mill-like member (2) towards the oral cavity. The angle theta (0) ranges from 0° to 90°, as to accommodate the desired angle of the dental prosthesis structure to be attached to the abutment (3).

It is yet in the scope of the present invention wherein the mill-like member (2) is having an internal portion of diameter d2, as shown in FIG. 1, and a plurality of milling teeth thereon extending from said internal portion to the circumference of said milling surface (105), wherein d2 is equal or greater than d and is less then d1. The number of milling teeth n according to one embodiment is an integer ranging from 16 to 42. According to a further embodiment, n ranges from 22 to 38.

According to one embodiment, the milling surface is substantially coplanar with the circumference plane of the external diameter d1, as shown by way of a non-limiting example in FIG. 8.

According to yet another embodiment, the milling surface is shaped in a truncated conic form with aperture angle alpha (α), as shown by way of a non-limiting example in FIG. 9.

According yet to a further embodiment, the root-replacement member may include therein at least one hole extending from one lateral end thereof to the opposite side, such that said hole is substantially parallel to the horizontal axis (B), so as to allow the bone tissue to grow inside the implant body for improved osseointegration.

The dental implant in accordance with the invention is fabricated from materials selected in a non-limiting manner from the group consisting of titanium or titanium alloys, stainless steel, polymeric materials or compositions, composite materials, or any other suitable implant material which can withstand functional loads and support crowns, bridge segments, or the complete replacement of teeth with tooth forms/synthetic teeth/artificial teeth.

The dental implant according to the invention is available either single-handedly and/or as a part of a dental construction installed in a patient's mouth comprising a plurality of dental implants.

The dental implant according to the invention is either a single-part, monobloc unit, or a kit comprising at least two components: a root replacement drilling member, and, a milling member; said components are attachable one to each other by means selected in a non-limiting manner from screws; pins; grooves; dies; pressure, vacuum or magnet closure; or any combination thereof.

According to a further embodiment the kit additionally comprises an abutment component.

What is claimed is:

1. A dental implant anchored to the jawbone by at least two immobilizing means in the jawbone's intrabony portions comprising the proximal crest, medulla and distal crest; suprabony portions or any combination thereof such that the implant is rendered durable to withstand both lateral and perpendicular forces.

2. A dental implant according to claim 1 anchored to the jawbone by at least two immobilizing means in the jawbone's, characterized by a multi-screw shape adapted for be entrapped in jawbone's proximal crest, medulla and distal crest.

3. A multi-screw, trans-endodontal implant, characterized by a distal portion penetrating the jawbone, and a proximal portion facing the oral cavity, comprising:
a. a head member located at said proximal portion, having a central bore therein for receiving a dental prosthesis;
b. at least one elongated screw-like envelope member, comprising an external sheath having an outer threaded surface and an internal cylindrical shaft extending from said head member to the distal end of said envelope member, said shaft is further adapted for accommodating therein an inner screw-like member; and,
c. at least one inner screw-like member, having an elongated, threaded distal body portion, and a cylindrical proximal body portion having a circumferential O-ring disposed thereon, and a furrowed, hexagonal shaped cavity located at the proximal end thereof;
wherein said envelope screw-like member is penetrating the proximal crest and medulla layers of the jawbone, and the inner member is further exceeding perpendicularly from the distal end of the said envelope member into the second crest layer.

4. The trans-endodontal implant according to claim 3, comprising a single envelope member and a single inner member, assembled into a double-screw implant.

5. The trans-endodontal implant according to claim 3, wherein said envelope member is shaped in a substantially cylindrical form.

6. The trans-endodontal implant according to claim 3, wherein said inner member is shaped in a substantially cylindrical form.

7. The trans-endodontal implant according to claim 3, wherein said envelope member is shaped in a substantially conic form.

8. The trans-endodontal implant according to claim 3, wherein said inner member is shaped in a substantially conic form.

9. The trans-endodontal implant according to claim 3, wherein a plurality of envelope and/or inner members is accommodated one inside the other forming a telescope-like echeloned structure.

10. The trans-endodontal implant according to claim 9, wherein said envelope and/or inner members are of cylindrical shape.

11. The trans-endodontal implant according to claim 9, wherein said envelope and/or inner members are of conic shape.

12. The trans-endodontal implant according to claim 9, combining envelope and/or inner members of both cylindrical and conic shapes.

13. The trans-endodontal implant according to claim 3, wherein the inner screw-like member is further having a tapered tip in the distal end thereof.

14. The trans-endodontal implant according to claim 13, wherein said tip is shaped in a substantially convex form, selected from the group consisting of tapered cone; truncated cone; polyhedron; pyramid; flat disc; or any similar three-dimensional geometrical form.

15. The trans-endodontal implant according to claim 13, wherein said tip is shaped in a substantially concave form.

16. The trans-endodontal implant according to claim 13, wherein said tip is having thereon bone glue or any similar adhesive composition.

17. The trans-endodontal implant according to claim 3, wherein the envelope member is having at least one flute in the distal end thereof.

18. The trans-endodontal implant according to claim 3, wherein the inner member is having at least one flute in the distal end thereof.

19. The trans-endodontal implant according to claim 3, wherein the inner member is having two flutes disposed in opposite directions at the distal end thereof.

20. The trans-endodontal implant according to claim 3, wherein the envelope member is having three flutes disposed at radial angle of about 120° against each other in the distal end thereof.

21. The trans-endodontal implant according to claim 3, wherein the central bore within the head member is in hexagonal shape.

22. The trans-endodontal implant according to claim 3, wherein the central bore within the head member is having an internal threaded female groove.

23. The trans-endodontal implant according to claim 3, wherein the internal cylindrical shaft comprising at least one proximal portion having a diameter smaller than the diameter of the inner member's cylindrical body portion.

24. The trans-endodontal implant according to claim 3, wherein the internal cylindrical shaft comprising at least one proximal portion having a diameter smaller in about 50% than the diameter of the inner member's cylindrical body portion.

25. The trans-endodontal implant according to claim 3, wherein the internal cylindrical shaft comprising at least one proximal portion having a diameter smaller in about 30% than the diameter of the inner member's cylindrical body portion.

26. The trans-endodontal implant according to claim 3, further including milling means.

27. The trans-endodontal implant according to claim 3, wherein said envelope member further comprising at least one hole extending from one lateral end and throughout the internal portion to an opposite side thereof.

28. The trans-endodontal implant according to claim 3, wherein said head member is having means for accommodating an abutment cup, a healing cup or a splint.

29. The trans-endodontal implant according to claim 3, further adapted for self-drilling.

30. The trans-endodontal implant according to claim 3, wherein said head member further includes a stationary or mobile joint for adjusting the angle of an abutment portion attached thereto.

31. A method for implanting the multi-screw, trans-endodontal dental implant as defined in claim 3 or in any of its dependent claims, inter alia comprising:
a. drilling into the jawbone at least one bore hole adapted for accommodating the said envelope member;
b. screwing the said envelope member into said bore hole such that the external sheath thereof is penetrating perpendicularly the proximal crest and medulla layers;
c. drilling into the jawbone a second bore hole within the first bore hole for accommodating the inner member; and,
d. screwing said inner member into the second bore hole by means of fastening a bolting tool having a hexagonal pillar shaped end in accordance with the cavity of said inner member;
such that the inner member is further exceeding perpendicularly from the distal end of the said envelope member into the second crest layer.

32. The method according to claim 31, further comprising gluing the distal end tip of the inner member to the distal cortical bone.

33. The method according to claim 31, further comprising the step of milling the suprabony portion of the jawbone for fixating the implant thereto.

34. The method according to claim 31, wherein the implant is adapted for self-drilling and the steps of drilling and screwing the envelope and/or inner member are performed simultaneously.

35. A kit for a multi-screw, trans-endodontal implant according to claim 3, comprising:
a. an abutment module; said abutment module comprises a head component, having therein a housing member for receiving a dental prosthesis structure; and,
b. a root replacement anchoring module; said anchoring module comprises a multi-screw system having at least one screw-like envelope component and at least one inner screw-like component;
wherein said envelope component includes an outer portion comprising an elongated sheath having an external male threaded surface, and an inner portion comprising an internal cylindrical shaft extending throughout the longitudinal axis of said envelope component; the inner screw-like component comprises a screwing member, a sealing member, and a fastening member, the screwing member is having a male threaded surface adapted for accommodating the cortical region of the jawbone, the fastening member comprises a cylindrical body portion and a hexagonal shaped cavity located at the end thereof and facing outwardly of said inner component, and the sealing member comprises a circumferential O-ring disposed on said cylindrical body of the fastening member.

36. A dental implant characterized by at least two immobilizing means, combining self-drilling and/or self-milling means, characterized by an elongated main (vertical) axis having a proximal portion facing the oral cavity, and a distal portion penetrating into the jawbone, comprising:
a. an elongated, threaded surface body, root-replacement drill-like member located at said distal portion, having an external diameter d, a length l and a longitudinal axis coinciding with said implant's main axis;
b. a rounded, mill-like member having an external diameter d1 centered in said implant's main axis and coaxial with a secondary (horizontal) axis located in a right angle with said implant's main axis, said mill-like member is characterized by a jagged milling surface in the distal end thereof facing the jawbone;
c. an abutment located in the proximal end and exceeding from said mill-like member towards the oral cavity;
wherein said drill-like member is adapted to penetrate perpendicularly to a depth of about l as to accommodate an intrabony portion of the jawbone, while the mill-like member is fixated in a diameter d1 to a suprabony portion of the jawbone, such that the implant is rendered durable to withstand both lateral and perpendicular forces.

37. The dental implant according to claim 36, wherein the abutment is exceeded in an angle theta (θ) from the mill-like member towards the oral cavity.

38. The dental implant according to claim 36, wherein said mill-like member is shaped in a truncated conic form.

39. The dental implant according to claim 36, wherein said mill-like member is in the shape of a disc.

40. The dental implant according to claim 36, wherein said mill-like member has a polygonal shape.

41. The dental implant according to claim 36, wherein the mill-like member is having an internal portion of diameter d2 and a plurality of milling teeth thereon extending from said internal portion to the circumference of said milling surface, wherein d2 is equal or greater than d and is less then d1.

42. The dental implant according to claim 41, wherein the number of milling teeth n is an integer ranging from 16 to 42.

43. The dental implant according to claim 42, wherein n ranges from 22 to 38.

44. The dental implant according to claim 36, wherein the root replacement member is having a smooth body surface adapted for insertion into a pre-drilled borehole.

45. The dental implant according to claim 36, wherein the drill-like member is having at least one flute in its distal end.

46. The dental implant according to claim 36, wherein the milling surface is coplanar with the circumference plane of the external diameter d1.

47. The dental implant according to claim 36, wherein the milling surface is shaped in a truncated conic form with aperture angle alpha (α).

48. The dental implant according to claim 36, wherein the root-replacement member is further including at least one hole therein extending from one lateral end thereof to the opposite side and substantially parallel to said horizontal axis.

49. A method of treating humans by means of dental implant according to claim 36 such that a secure immobilization of the multi-screw, trans-endodontal dental implant as defined in claim 1 is provided with no significant implant movement, comprising:
a. drilling into the jawbone at least one bore hole adapted for accommodating the said envelope member;
b. screwing the said envelope member into said bore hole such that the external sheath thereof is penetrating perpendicularly the proximal crest and medulla layers such that a first anchoring plane is provided;
c. drilling into the jawbone a second bore hole within the first bore hole for accommodating the inner member; and,
d. screwing said inner member into the second bore hole by means of fastening a bolting tool having a hexagonal pillar shaped end in accordance with the cavity of said inner;
such that the inner member is further exceeding perpendicularly from the distal end of the said envelope member into the second crest layer and a second anchoring plane is provided.

50. The method according to claim 49, wherein the implant is adapted for self-drilling and the steps of drilling and screwing the envelope and/or inner member are performed simultaneously.

51. A kit for a dental implant according to claim 36 combining self-drilling and/or self-milling means, comprising:
a. an elongated root replacement drilling component; and,
b. a milling component;
wherein the components are attachable one to each other by means selected from screws; pins; grooves; pressure, vacuum or magnet closure; or any combination thereof.

52. The kit according to claim 51, further comprising an abutment component.

53. The method according to claim 51 by means of a kit for a multi-screw, trans-endodontal implant, said kit comprising:
a. an abutment module; said abutment module comprises a head component, having therein a housing member for receiving a dental prosthesis structure; and,
b. a root replacement anchoring module; said anchoring module comprises a multi-screw system having at least one screw-like envelope component and at least one inner screw-like component;
wherein said envelope component includes an outer portion comprising an elongated sheath having an external male threaded surface, and an inner portion comprising an internal cylindrical shaft extending throughout the longitudinal axis of said envelope component; the inner screw-like component comprises a screwing member, a sealing member, and a fastening member, the screwing member is having a male threaded surface adapted for accommodating the cortical region of the jawbone, the fastening member comprises a cylindrical body portion and a hexagonal shaped cavity located at the end thereof and facing outwardly of said inner component, and the sealing member comprises a circumferential O-ring disposed on said cylindrical body of the fastening member.

54. A method for implanting a dental implant combining self-drilling and self-milling means according to claim 36, said method comprising:
a. drilling said implant into the intrabony portion of the jawbone; so that said self-drilling means penetrate perpendicularly to a predetermined depth l as to accommodate said intrabony portion; and,
b. milling said implant into the suprabony portion of the jawbone; so that the mill-like member is fixated in a predetermined diameter d1 to a suprabony portion of the jawbone;
wherein the combination of drilling and milling renders the implant durable to withstand both lateral and perpendicular forces.

55. The method according to claim 54, wherein the step of drilling is performed by means of a surgical tool adapted to pre-drill a borehole in the jawbone.
